(19) United States
(12) Patent Application Publication
(10) Pub. No.: US 2007/0185989 A1
(43) Pub. Date: Aug. 9, 2007

(54) Integrated video surveillance system and associated method of use

(76) Inventors: Thomas Grant Corbett, Eureka, MO (US); Timothy James Dye, Ellisville, MO (US); Daniel Jan Deren, Staunton, IL (US)

Correspondence Address: THOMPSON COBURN, LLP, ONE US BANK PLAZA, SUITE 3500, ST LOUIS, MO, 63101, US

(21) Appl. No.: 11/348,840

(22) Filed: Feb. 7, 2006

(51) Int. Cl. G06F 15/173

(52) U.S. Cl. 709/224

(57) ABSTRACT

An integrated video surveillance system and associated method of use is disclosed that includes at least one alarm monitoring center, each alarm monitoring center includes a main control panel with a first video recorder interface, at least one subscriber, wherein each subscriber is electrically connected to a control module, at least one mobile unit, wherein each mobile unit includes at least one first electronic display and is electrically connected to a wireless access network, at least one video camera for providing video data of a predetermined area, and at least one computer network, which includes a global computer network, that is operatively connected between the at least one alarm monitoring center, the at least one subscriber, the at least one video camera and the at least one mobile unit through the wireless access network.

### TECHNICAL FIELD OF THE INVENTION

The present invention relates to video surveillance, particularly an improved technique for remotely monitoring a facility by collecting video data from video surveillance equipment and transmitting the video data from the video surveillance equipment through a global computer network, e.g., the Internet.

### BACKGROUND OF THE INVENTION

Existing video surveillance systems employ video cameras, e.g., digital video cameras, and video recording devices, e.g., digital video recorders (DVRs). Existing video surveillance systems may also employ alarm sensors, e.g., heat sensors, smoke detectors, door and/or window switches, light sensors, motion detectors, and sound sensors. For example, a sound sensor can be set-up to detect predetermined sounds that are helpful in security, such as the breaking of glass. Therefore, when a sensor is activated, an associated video camera can be triggered to transmit video images from the area of the sensor to a central monitoring station for observation, recording, and/or review. Typically, the video, from all of the video cameras, is transmitted to the central monitoring station and then viewed by security personnel within a facility.

One of the more serious problems with this approach is that the individuals arriving at the scene of interest to provide assistance can be completely uninformed as to what is occurring at the scene and only have general verbal information. These individuals can include government employees, e.g., law enforcement personnel, fire protection personnel, Department of Homeland Security Personnel, FBI Agents, CIA Agents, and so forth, as well as additional security personnel and any other employee or other individuals whose safety and job performance can be hampered by not knowing what is going on at a specific physical location prior to physically arriving at the scene. Another major problem is that security personnel are typically located at a central monitoring station and must be dispatched to an area of concern. This can involve a significant delay by the time the security personnel reach the scene of interest. During this time, the situation at the scene of interest may change dramatically by the time the security personnel leave the central monitoring station and actually arrive at the scene. This can pose a direct threat to the safety of the personnel involved and, at the very least, can dramatically decrease job effectiveness.

The present invention is directed to overcoming one or more of the problems set forth above.

### SUMMARY OF INVENTION

In an aspect of this invention, the present invention includes a video surveillance system that can utilize existing global computer network technology, e.g., the Internet, to make the video data and/or audio data available anywhere. By using the global computer network technology, e.g., the Internet, to transmit the video data and/or audio data, the present invention eliminates having separate security arrangements or network arrangements for monitoring. Instead, the existing global computer network technology, e.g., the Internet, can be utilized for access to the video data and/or audio data at any location and not just at a central monitoring station. In addition, video data and/or audio data can be directly transmitted to a mobile unit's display through a wireless network. The mobile unit can mounted in a motorized vehicle as well as being portable for use by personnel on foot.

In another aspect of this invention, the present invention includes a video surveillance system that allows for a reduction in the amount of data that is transmitted from video cameras to the video storage devices and electronic display monitors. Alarm sensors, e.g., heat sensors, smoke detectors, door and/or window switches, light sensors, motion detectors, and sound sensors, can be utilized to determine if the data that is being sent from a camera should be transmitted in high quality and at a high rate of data transmission rather than a low quality and low data transmission when the sensor has not been activated. This reduction in transmitted data reduces the bandwidth required to transmit the video data from the video cameras. Moreover, this reduction in bandwidth eliminates the need to have a dedicated circuit for each video camera thereby reducing the installation costs for a video surveillance system. In addition, the need for constant monitoring of the video data from all of the video cameras is eliminated if the user is alerted when a sensor is activated and only that particular feed of video data from this particular area or sector is transmitted, displayed, and/or recorded.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 illustrates a schematic view of the advanced surveillance environment system according to the present invention;

FIG. 2 illustrates a diagrammatic view of the advanced surveillance environment system according to the present invention; and

FIG. 3 illustrates a flow chart of a video communication system, associated with the present invention, utilizing an illustrative, but nonlimiting, digital video recorder (DVR).

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so that the present invention will not be obscured.

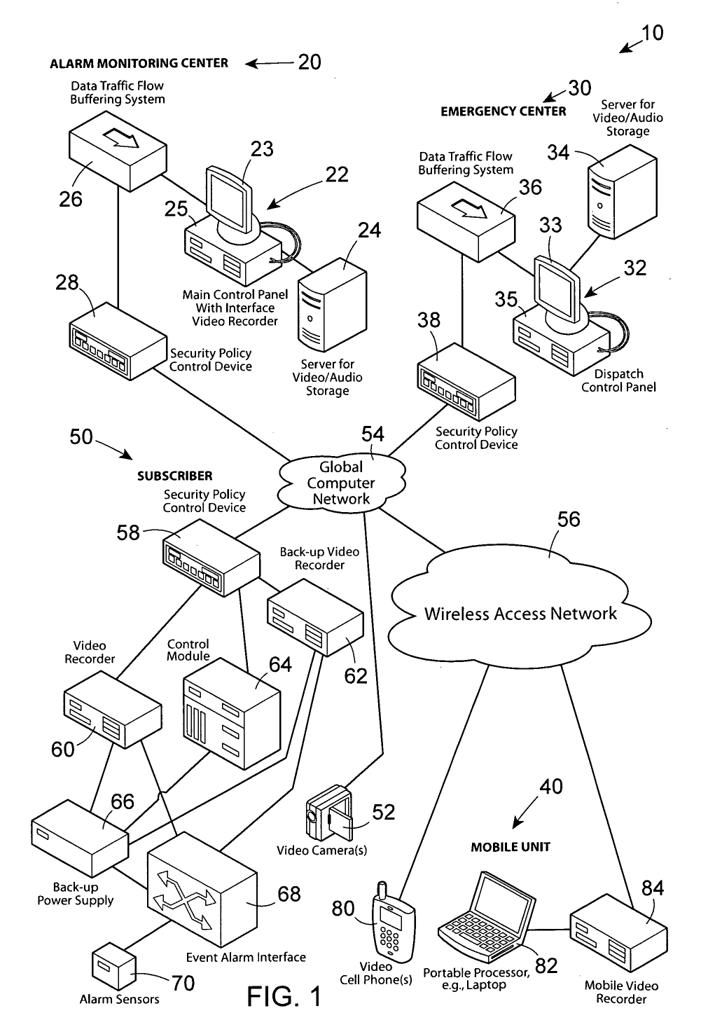

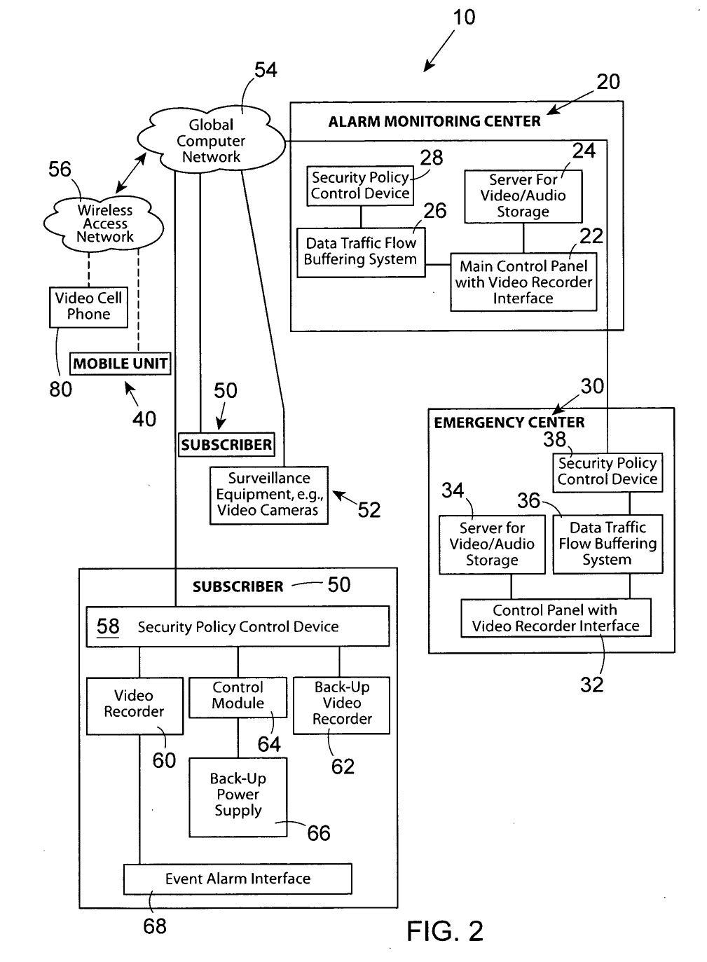

Referring to the accompanying drawings, FIG. 1 illustrates a schematic view and FIG. 2 illustrates a diagrammatic view of a video surveillance system according to the present invention that is generally indicated by numeral 10. In this present invention, video surveillance equipment 52, e.g., video cameras, transmit video data streams over a global computer network 54, e.g., the Internet. Moreover, the present invention allows instantaneous access to the video streams at any one of four types of surveillance units: an alarm monitoring center 20; an emergency center 30; a mobile unit, e.g., law enforcement vehicle, 40; and a subscriber 50. This present invention utilizes video surveillance equipment, e.g., video cameras, 52 that are positioned at various remote locations and are equipped with connectivity to a global computer network 54, e.g., the Internet. Preferably, this connectivity includes utilization of communication protocols such as Transmission Control Protocol/Internet Protocol (TCP/IP), which is a suite of communications protocols used to provide data communication on a global computer network 54, e.g., the Internet. TCP/IP uses several protocols, the two main ones being TCP and IP. Although the IP protocol only involves data packets, TCP enables hosts to establish a connection and exchange streams of data. The Transmission Control Protocol (TCP) guarantees the delivery of video data and also guarantees that the video data packets will be delivered in the same order in which they were transmitted.

The live video data streams are transmitted from the video surveillance equipment, e.g., video cameras, 52 and received by a main control panel 22, which preferably includes an electronic display monitor 23 and a video recorder interface 25. An illustrative, but nonlimiting, example of a video data interface 25, preferably utilizes Serial Digital Interface (SDI). SDI is a physical software interface widely used for transmitting digital video data in a variety of formats through a wired or wireless network by utilizing different types of ports and connection settings. SDI employs software applications to enable users to utilize different types of video stream devices with different remote view applications merged into one standard remote viewing interface for multiple video monitoring purposes.

Some functions that SDI allows the user to perform include: controlling video surveillance equipment such as video cameras 52 and video recorders 60, 62; recording of retrieved video data streams from remote video surveillance equipment 52, e.g., video cameras; viewing received video data streams in a variety of formats, e.g., Wavelet, MPEG-4, etc., as well as audio data streams from multiple locations; retrieving, previewing, backing up, or editing stored video data history; managing of assigned users including privileges, and passwords; distributing selected remote video data streams to a different location; and combining and viewing video data streams from multiple types of surveillance video recording equipment, e.g., video recorder 60 and back-up video recorder 62.

Specifically, the Serial Digital Interface (SDI) software enables a user to do the following: watch live video streams from multiple locations at the same time; watch live video from numerous video camera channels, e.g., twelve hundred (1,200) video camera channels; listen to stream audio from numerous monitored video camera locations, e.g., 800 video camera locations; preview live video on screen from numerous video camera sources, e.g., sixty-four (64) video camera sources, at the same time; adjust viewing preferences for an electronic monitor 23 and 33 such as contrast, brightness, audio volume, hue and saturation; change the setup of a video recorder 60, 62; record video and audio from the monitored location into a locally designated storage device, e.g., a hard drive; download selected sections of recorded and previously saved audio files and video files by choosing the date and time for a designated video recording device 60, 62 and then extract the video files and save these video files on a designated video recording device 60, 62; customize live video data and audio data preview, adjust the number of video surveillance equipment, e.g., video cameras, 52 that are displayed, alter the pixel size of each frame and the refresh rate; control the zoom function, pan, tilt, resolution, and other settings for video surveillance equipment, e.g., video cameras, 52; and send saved video data to a storage device, e.g., servers for video and audio data 24 and 34.

The alarm monitoring center 20 includes a main control panel 22 that includes an interface 25 for a video camera, e.g., digital video recorder interface. The main control panel 22 can be electrically connected to a server for video and/or audio data 24, where the server for video and/or audio data provides storage for files of video data and/or audio data. The server for video and/or audio data 24 is optional and provides for additional data storage.

The main control panel 22 is electrically connected to a traffic flow buffering system 26. A traffic flow buffering system 26 actively or passively regulates the flow of streaming video data. This system smoothes the differences between bandwidth of different computer networks, e.g. WAN, LAN, etc., and regulates the video data and/or audio data that is sent to another monitoring location. Also, the traffic flow buffering system 26 may optionally support memory caching to improve restart times.

The traffic flow buffering system 26 is electrically connected to a security policy control device 28 that controls real-time interactive communications across network borders, e.g., Internet Protocol (IP) through either crossing or peering over a border for a computer network. For example, this security policy control device 28 makes it possible for surveillance video data streams to cross firewalls such that they are transmitted to a global computer network 54, e.g., Internet, by the emergency center 30 and received by the alarm monitoring center 20, the subscriber 50, and a mobile unit 40, e.g., law enforcement vehicle. The security policy control device 28 can support one or more signaling protocols associated with session management. Illustrative, but nonlimiting, examples of signaling protocols include SIP, H.323, or MGCP/NCS.

Session Initiated Protocol or Session Initiation Protocol (SIP) is an application-layer control protocol that includes a signaling protocol for telephony over a global computer network 54, e.g., the Internet. SIP can establish sessions for features such as audio/videoconferencing and call forwarding to be deployed over a global computer network 54, thus enabling service providers to integrate basic telephony services with other services. In addition to user authentication, redirect, and registration services, an SIP server supports traditional telephony features such as personal mobility, time-of-day routes and call forwarding based on the geographical location of the person being called. H.323 is a standard protocol that defines how audiovisual conferencing data is transmitted across networks. In theory, H.323 should enable users to participate in the same conference even though different videoconferencing applications are being utilized. Media Gateway Control Protocol (MGCP) is a control and signal standards protocol for the conversion of audio signals carried on telephone circuits to data packets carried over a global computer network 54, the Internet, or other packet-type networks.

The security policy control device 28 is also capable of controlling the RTP and RTCP flows associated with the voice, video, or multimedia session content. Real-Time Transport Protocol (RTP) is a protocol for a global computer network, e.g., the Internet, 54 for transmitting real-time data such as audio and video. RTP itself does not guarantee real-time delivery of data, but it does provide mechanisms for the sending and receiving applications to support streaming video data and/or audio data. Real-Time Control Protocol (RTCP) is a companion protocol to RTP that is used to analyze network conditions and periodically send data packets that report on congestion of the network.

When the security policy control device 28 transmits the video and/or audio data to the global computer network 54, e.g., Internet, it is then available to be received by the subscriber 50. The present invention can be utilized with any of a wide variety of subscribers such as government, residential and mobile across any of a wide variety of networks including wired and wireless networks such as, but not limited to leased line, frame relay, digital subscriber line (DSL), cable, Wi-Fi, 3G, satellite, and so forth.

The subscriber unit 50 also includes a security policy control device 58, similar to security policy control device 28, for receiving the video data and/or audio data. This security policy control device 58 is connected to at least one video recorder 60 as well as a control module 64 for controlling at least one video recorder. Optionally, there is at least one back-up video recorder 62. Preferably, but not necessarily, the video recorders 60, 62 are digital video recorders (DVRs). Also, it is preferred that the control module 64 allows switching between the at least video recorder 60 and the at least one back-up video recorder 62 in the event of an electrical, mechanical, and/or operational failure.

Preferably, the video recorders 60, 62 as well as other electronic surveillance equipment are electrically connected to a back-up power supply 66, e.g., smart DC back-up unit (SDB), that provides power to surveillance equipment, e.g., video recorders 60, 62 for a specific amount of time after the initial power source is shut off. The back-up power supply 66 also monitors the overall subscriber surveillance system 50 by looking for errors in overall system stability, voltage, and temperature. The back-up power supply 66 is preferably, but not necessarily, an electronic device equipped with sensor inputs to monitor different characteristics of surrounding electronic equipment that are connected by hardwire. Optionally, the back-up power supply 66 is equipped with a port, e.g., TCP/IP port, to update the user with the latest readouts and conditions. The sensors attached to the back-up power supply 66 can monitor temperature, voltage, moisture, and/or power consumption.

Preferably, the back-up power supply 66 includes at least one sensor input port that can be attached to monitoring equipment. A sensor can monitor circuit boards, transistors, DC voltage terminals, and so forth. Also, the preferred embodiment of the back-up power supply 66 can include a processor that analyzes the data from at least one sensor. If there is any fluctuation in data that is detected, an alarm is activated and the user is notified.

Also, the back-up power supply 66 preferably includes preprogrammed values of safe temperature, voltage, and moisture. Moreover, it is preferred that scheduled updates can be conducted at any time and can transmit messages with the latest readouts that can be programmed to be monitored in real time. The back-up power supply 66 can monitor different pieces of equipment simultaneously as well as provide output data via ports, e.g., printer ports.

The operation of a preferred digital video recorder 60, 62 is disclosed in U.S. Patent Application No. 2004/0146282, filed on Jan. 15, 2005 and published Jul. 29, 2004 to Young Wook Lee, which is incorporated herein by reference in its entirety.

There is an event alarm interface that is generally indicated by numeral 68. The event alarm interface 68 links the surveillance equipment together including the video recorder 60 and the back-up video recorder 62. Also, the event alarm interface 68 provides protection for the surveillance equipment from lightning strikes and power surges. In addition, the event alarm interface 68 is also electrically connected to a variety of alarm sensors 70 that are typically, but not necessarily triggered by an event. Illustrative examples of these types of alarm sensors 70 include, but are not limited to, heat sensors, smoke detectors, door and/or window switches, light sensors, motion detectors, and sound sensors. These alarm sensors 70 increase security performance by providing input when video images are insufficient such as when there is smoke, fire, or insufficient lighting. The alarm sensors 70 can also operate as a back-up when video cameras 52 are not operational. The alarm sensors 70 can also be utilized to keep the bandwidth of the video data at a lower predetermined level when not activated and have the bandwidth increased to a higher predetermined level only when at least one alarm sensor 70 is activated. The utilization of alarm sensors 70 eliminates the need for dedicated circuitry for each video camera 52 as well as the constant monitoring and/or recording of video data.

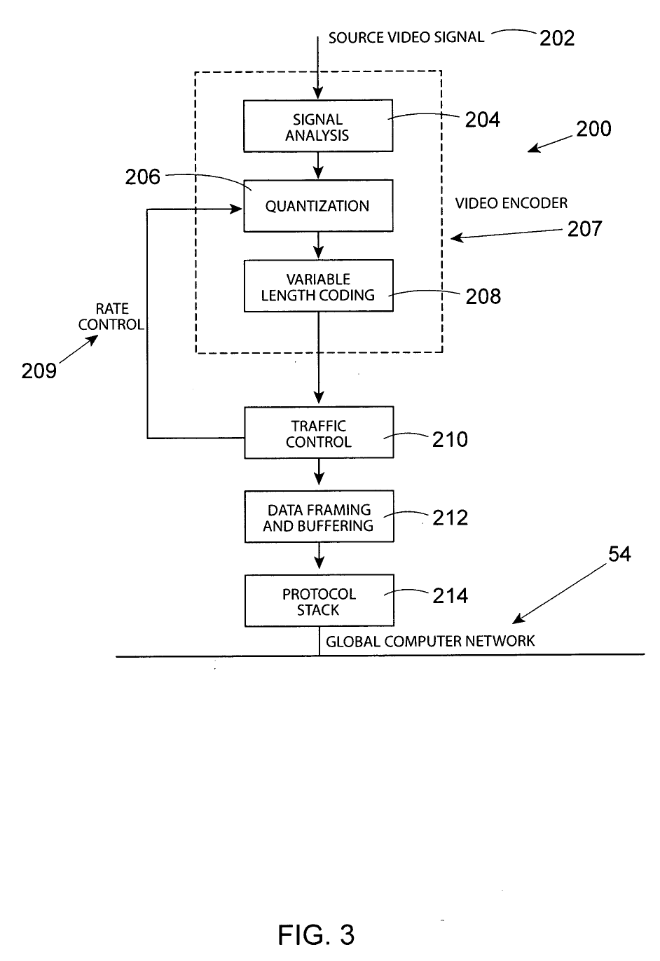

An illustrative, but nonlimiting, description of a video communication system is illustrated in FIG. 3. A flowchart of the process is generally indicated by numeral 200. In the description of the flowchart, the functional explanation marked with numerals in angle brackets <nnn>, will refer to the flowchart blocks bearing that number. The first step in the process <204> is to analyze the supplied analog video signal. The analysis can include such operations as: filtering; analog to digital conversion; computations of transform coefficients; and/or correlation of the pixels with pre-stored vector quantization patterns. An output accuracy of such an analysis typically varies with a predetermined number of bits, e.g., 8 to 12 bits. Usually no compression is performed with this type of analysis. The data is only transformed to a format that is more compressible than the original signal format.

The second step <206> performs quantization of the signal, in either a lossless or lossy way. In a lossy system, the quantizer reduces signal accuracy in a way that is as acceptable as possible to the human eye.

The third step <208> is a variable length coding block. In the variable length coding process step <208>, each signal event will have a code with different number of bits, which is known as “entropy coding.” To obtain compression, short codes are assigned to frequently occurring events and long codes are assigned to infrequent events.

The fourth process step is a traffic control function <210> that follows data flow status in a communication channel, adjusts encoder parameters, which is indicated as rate control 209 in FIG. 3, according to the data flow status in order to adapt generated video data to the communication channel and control the quantization step <206>. These first three (3) process steps <204>, <206> and <208> are indicated by numeral 207 as the video encoding process.

The fifth process step <212> forms data packets according to a predetermined protocol. The fifth process step <212> also buffers the data packets in order to provide a continuous and smooth data stream to the communication channel. Such system parameters, such as buffer size and data packet length, are very essential for the system performance, and therefore must be designed with care. If the Real Time Protocol (RTP) is used on top of a transport protocol layer, RTP provides necessary information for which the data parameter determination can be based. With the reception of a video data stream, a receiver must know the format of the received data.

In an illustrative, but nonlimiting, format, H.323 compliant applications negotiate in the beginning of a communication session to find a suitable format for both sides. When data reception starts, a goal is that the receiver should serve video frames to its decoder equally to those frames that were generated by a sender. Because of data packet delay variations in the transfer path, received data packets must be buffered to get required tolerance for delay variations. This “ring buffer” implementation is a common solution at the receiver end. In order to have more tolerance for the delay variations, more video data must be buffered. Accordingly, this creates a longer “offset” delay. This may cause an optimization problem between the communication delay and a defined level of performance in a data communication system (QoS).

In addition to the buffering task, the receiver must also check the order of the data packets and rearrange them if necessary <214>, and decide what to do in case of erroneous or lost data packet. The Real Time Protocol (RTP) protocol helps greatly to implement these functions by offering required parameters such as a creation time stamp in the header of each packet. These ordered data packets can then enter the global computer network 54, e.g., the Internet.

An event alarm interface 68 is connected to the subscriber video recorders 60, 62 and the existing security equipment. Security systems typically monitor a premise by separating it into smaller areas or zones. Through the event alarm interface 68, the surveillance system can be connected to a security zone or multiple zones. When the security system detects an intrusion, this alarm sensor 70 will then be communicated to the surveillance system through the event alarm interface 68. The main control panel 22 in the emergency center 20 can then use this alarm information to, among other things, determine which video camera is displayed on the electronic displays, determine the speed and quality of the video and audio being transmitted from the video camera in the zone with the alarm, or notify a user of an alarm in that particular zone.

The emergency center and dispatch 30 is structured similar to the alarm monitoring center 20. This includes a dispatch control panel 32 that includes an interface 35 for a video camera, e.g., digital video recorder interface. The dispatch control panel 32 is electrically connected to a video server 34, where the video server 34 provides storage for files of video data and/or audio data. The video server 34 is optional and provides for additional data storage. The dispatch control panel 32 is also electrically connected to an electronic display 33.

The dispatch control panel 32 is electrically connected to a traffic flow buffering system 36. A traffic flow buffering system 36 actively or passively regulates the flow of streaming video data. This traffic flow buffering system 36 smoothes the differences between WAN and LAN bandwidth, regulates the data that is sent to another monitoring location, and supports memory caching to improve restart times.

The traffic flow buffering system 36 is electrically connected to a security policy control device 38 that controls real-time interactive communications across network borders, e.g., Internet Protocol (IP). This security policy control device 38 makes it possible for surveillance video streams to easily access or peer across firewalls such that they are transmitted to a global computer network, e.g., Internet, from the emergency center 30 and received by the alarm monitoring center 20, the subscriber 50, and a mobile unit 40, e.g., law enforcement vehicle. The security policy control device 38 can support one or more signaling protocols associated with session management.

The mobile unit 40 can include an electronic display and/or audio speaker that is located in a motorized vehicle utilized by governmental, e.g., police, or security personnel so that these individuals can preferably review the situation from outside of the premises. The emergency center 30 can also receive input from surveillance equipment 52, e.g., video cameras. A preferred type of video camera is a digital camera that utilizes Internet Protocol (IP). The mobile unit 40 may also include a portable processor 82, e.g., laptop computer, which can be connected to a portable video recorder 84 as shown in FIG. 1.

Access to the alarm monitoring center and response dispatch can also be performed with a wireless cell phone 80 that preferably includes an electronic display for video data as well as audio data.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

1. An integrated video surveillance system comprising:
at least one alarm monitoring center, wherein each said alarm monitoring center includes a main control panel with a video recorder interface;
at least one subscriber, wherein each said subscriber is electrically connected to a control module;
at least one mobile unit, wherein each said mobile unit includes at least one first electronic display and each said mobile unit is electrically connected to a wireless access network;
at least one video camera for providing video data of a predetermined area; and
at least one computer network, which includes a global computer network, that is operatively connected between said at least one alarm monitoring center, said at least one subscriber, said at least one video camera and said at least one mobile unit through said wireless access network.

2. The integrated video surveillance system as set forth in claim 1, wherein each said alarm monitoring center includes a first data traffic flow buffering system that is operatively connected to said main control panel and a first security policy control device that is operatively connected to said first data traffic flow buffering system, wherein said first security policy control device is operatively connected to said global computer network.

3. The integrated video surveillance system as set forth in claim 2, wherein said first data traffic flow buffering system provides features from the group consisting of:
streaming of video data, increasing data buffering capacity;
alleviating differences between bandwidth for different computer networks;
regulating data flow; or
providing increased memory catching to improve restart times.

4. The integrated video surveillance system as set forth in claim 2, wherein said first security policy control device controls video, audio and multimedia data flow across network borders for said at least one computer network.

5. The integrated video surveillance system as set forth in claim 4, wherein said video, audio and multimedia data flow across network borders for said at least one computer network includes utilizing signaling protocol selected from the group consisting of SIP, H.323 or MGCP/NCS, wherein said video, audio and multimedia data flow are selected from the group consisting of RTP data flows or RTCP data flows.

6. The integrated video surveillance system as set forth in claim 1, wherein said first video recorder interface is capable of receiving a plurality of data streams from a plurality of surveillance devices

7. The integrated video surveillance system as set forth in claim 6, wherein said video recorder interface controls operation of at least one of a plurality of video cameras and at least one of a plurality of video recorders.

8. The integrated video surveillance system as set forth in claim 1, wherein each said alarm monitoring center further includes a second electronic display.

9. The integrated video surveillance system as set forth in claim 1, wherein each said alarm monitoring center further includes a first server for storing at least one of video data and audio data.

10. The integrated video surveillance system as set forth in claim 1, further comprising at least one video camera for providing surveillance information that is operatively connected to said global computer network.

11. The integrated video surveillance system as set forth in claim 1, wherein each said subscriber includes an interface for receiving input from at least one alarm sensor.

12. The integrated video surveillance system as set forth in claim 11, wherein each said alarm sensor is selected from the group consisting of a heat sensor, a smoke detector, a door switch, a window switch, a light sensor, a motion detector, or a sound sensor.

13. The integrated video surveillance system as set forth in claim 11, wherein each said alarm sensor when activated results in said at least one alarm monitoring center to increase bandwidth of video data from a first lower predetermined level to a second higher predetermined level.

14. The integrated video surveillance system as set forth in claim 1, wherein each said subscriber includes at least one video recorder operatively connected to said control module.

15. The integrated video surveillance system as set forth in claim 14, further comprising at least one back-up video recorder that is operatively connected to said control module.

16. The integrated video surveillance system as set forth in claim 1, wherein said at least one subscriber is operatively connected to a back-up power supply.

17. The integrated video surveillance system as set forth in claim 1, further comprising at least one emergency center, wherein each said emergency center includes a dispatch control panel with a second video recorder interface.

18. The integrated video surveillance system as set forth in claim 17, wherein each said emergency center further includes a second data traffic flow buffering system that is operatively connected to said dispatch control panel and a second security policy control device that is operatively connected to said second data traffic flow buffering system, wherein said second security policy control device is operatively connected to said global computer network.

19. The integrated video surveillance system as set forth in claim 18, wherein each said emergency center further includes a third electronic display.

20. The integrated video surveillance system as set forth in claim 18, wherein said at least one emergency center further includes a second server for storing at least one of video data and audio data.

21. The integrated video surveillance system as set forth in claim 1, wherein said at least one mobile unit includes a cell phone capable of receiving at least one of video data and audio data.

22. The integrated video surveillance system as set forth in claim 1, wherein said at least one mobile unit includes a portable processor.

23. The integrated video surveillance system as set forth in claim 22, wherein said at least one mobile unit includes a mobile video recorder that is operatively connected to said portable processor.

24. An integrated video surveillance system comprising:
at least one alarm monitoring center, wherein each said alarm monitoring center includes a main control panel with a first video recorder interface and a first data traffic flow buffering system that is operatively connected to said main control panel and a first security policy control device that is operatively connected to said first data traffic flow buffering system;
at least one subscriber, wherein each said subscriber is electrically connected to a control module and an interface for receiving input from an alarm sensor;
at least one mobile unit, wherein each said mobile unit includes at least one first electronic display, wherein each said mobile unit is electrically connected to a wireless access network;
at least one video camera for providing video data of a predetermined area; and
at least one computer network, which includes a global computer network, that is operatively connected between said first data traffic flow buffering system, said at least one alarm monitoring center, said at least one subscriber, said at least one video camera and said at least one mobile unit through said wireless access network, wherein said first security policy control device controls video, audio and multimedia data across network borders for said at least one computer network.

25. An integrated video surveillance system comprising:
at least one alarm monitoring center, wherein each said alarm monitoring center includes a main control panel with a first video recorder interface;
at least one subscriber, wherein each said subscriber is electrically connected to a control module and each said subscriber includes an interface for receiving input from at least one alarm sensor selected from the group consisting of a heat sensor, a smoke detector, a door switch, a window switch, a light sensor, a motion detector, and a sound sensor;
at least one mobile unit, wherein each said mobile unit includes at least one first electronic display and each said mobile unit is electrically connected to a wireless access network;
at least one video camera for providing video data of a predetermined area; and
at least one computer network, which includes a global computer network, that is operatively connected between said at least one alarm monitoring center, said at least one subscriber, said at least one video camera and said at least one mobile unit through said wireless access network, wherein said at least one alarm sensor when activated results in said at least one alarm monitoring center to increase bandwidth of video data from a first lower predetermined level to a second higher predetermined level.

26. A method for performing video surveillance comprising:
utilizing at least one video camera for obtaining video data within a predetermined area;
providing said video data to at least one alarm monitoring center, wherein each said alarm monitoring center includes a main control panel with a first video recorder interface;
recording said video data with at least one subscriber, wherein each said subscriber is electrically connected to a control module and a video recorder;
providing said video data to at least one mobile unit, wherein each said mobile unit includes at least one first electronic display, wherein said at least one mobile unit is electrically connected to a wireless access network; and
interconnecting said at least one video camera, said at least one alarm monitoring center, said at least one subscriber and said wireless access network through at least one computer network, which includes a global computer network.

27. The method for performing video surveillance as set forth in claim 26, further including at least one selected from the group consisting of:
streaming of video data;
increasing data buffering capacity;
alleviating differences between bandwidth for different computer networks; or
regulating data flow or providing increased memory catching to improve restart times with a data traffic flow buffering system.

28. The method for performing video surveillance as set forth in claim 26, further including controlling video, audio and multimedia data across network borders for said at least one computer network with a security policy control device.

29. The method for performing video surveillance as set forth in claim 26, further including:
receiving input from at least one alarm sensor selected from the group consisting of a heat sensor, a smoke detector, a door switch, a window switch, a light sensor, a motion detector, or a sound sensor; and
increasing bandwidth of video data from a first lower predetermined level to a second higher predetermined level upon activation of said at least one alarm sensor.
